(19) United States
(12) Patent Application Publication
(10) Pub. No.: US 2022/0009295 A1
(43) Pub. Date: Jan. 13, 2022

(54) INTEGRATED TIRE MONITORING SENSOR CONTAINER

(71) Applicant: Compagnie Generale des Etablissements Michelin, Clermont-Ferrand (FR)

(72) Inventors: Daniel REY, Belton, SC (US); Bradley D SCHOBER, Greer, SC (US)

(21) Appl. No.: 17/294,640

(22) PCT Filed: Nov. 19, 2019
(86) PCT No.: PCT/US19/62146

§ 371 Date: May 17, 2021

Related U.S. Application Data
(60) Provisional application No. 62/769,417, filed on Nov. 19, 2018.

(51) Int. Cl. B60C 23/04; B29D 30/00

(52) U.S. Cl. CPC B60C 23/0493; B29D 2030/0072; B29D 30/0061

(57) ABSTRACT

The subject matter of the present invention relates to an integrally formed tire sensor container (100) for holding a tire sensor on the inner liner surface (70) within the cavity of a pneumatic tire (10). The container (100) has a base surface (110) surrounded by a peripheral wall (120) that extends from the base (110). An aperture (130) is formed by the peripheral wall (120) and has a maximum aperture diameter (132) smaller than a maximum wall diameter (126).

### FIELD OF THE INVENTION

The subject matter of the present invention relates to an integrally formed tire sensor container for holding a tire sensor on the inner liner surface within the cavity of a pneumatic tire.

### BACKGROUND OF THE INVENTION

The details and benefits of containers for holding sensors within the cavity of a pneumatic tire are described in prior patents, e.g. in U.S. Pat. Publication. No. US20130133800. Such containers necessitate, however, positioning of additional separating components and careful removal of such components once the molding is complete. The resulting container is flat, possesses an aperture adjacent to the inner liner, and does not lend itself to non-flat shaped sensors.

Other mold containers are added after the molding of the tire is complete, using green rubber or adhesive to bond a rubber container to the inner liner of the tire such as VDO REDI-Sensor™. Such non-integral sensor containers possess the desired shape unable to be achieved by prior art integrally molded containers, but require additional processing step and add to the weight of the tire and cost of the tire manufacturing.

What is needed is a container that may be molded integrally with the tire during the tire molding process that can accommodate a sensor having a bulkier shape than those allowed by prior art integrally molded tire sensor containers.

### SUMMARY OF THE INVENTION

Aspects and advantages of the invention will be set forth in part in the following description, or may be obvious from the description, or may be learned through practice of the invention.

In one exemplary embodiment, a container integrally formed with the inner liner of a tire adjacent to the crown ply reinforcements, the container having a base surface, a peripheral wall surrounding the base surface, the peripheral wall extending away from the base, the peripheral wall having an outer surface and an inner surface, and the peripheral wall having a maximum wall diameter measured between the inner surface of opposing portions of the peripheral wall and an aperture formed by the peripheral walls, where the aperture has a maximum aperture diameter smaller than the maximum wall diameter.

In another exemplary embodiment, the container is formed from the same elastomer as the inner liner of the tire.

In another exemplary embodiment, the container is formed from an elastomer composition that is different than the inner liner of the tire.

In at least one embodiment the container is formed under a tread groove of the tire.

A method for securing a sensor to a cured pneumatic tire is also disclosed herein. The method disclosed includes the steps of: providing a tire mold having an outer mold portion and a core portion, the core possessing a cavity into which is positioned a counter-molding plug; laying a quantity of uncured elastomer upon the core portion, the quantity of uncured rubber calculated to create sufficient pressure to force the rubber to flow into the space created between the cavity and the counter-molding plug during molding; closing the tire mold; heating the tire mold at a specified temperature profile for a specified period of time calculated to cure the uncured elastomer at the same time as the tire is cured; opening the tire mold; and removing the tire from the mold.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a cross section of a tire taken in a radial plane showing an integrally molded container for attaching a tire monitoring sensor.

FIG. 2 provides a perspective partial view of the radially inner side of the tire showing the integrally molded container.

FIG. 3 provides a perspective partial view of the integrally molded container for attaching a tire monitoring sensor.

FIG. 4 provides a cross section of the integrally molded container taken in a radial plane bisecting the container.

FIG. 5 provides an elevation view of the container from the radially inner side of the tire.

FIG. 6 provides a perspective partial view of the integrally molded container and a tire monitoring sensor contained there within.

FIG. 7 provides a cross-section of a tire mold used for molding the integrally molded container taken along the equatorial plane of the mold in the orientation of the equatorial plane of the tire.

FIG. 8 provides a perspective view of the counter molding plug portion of the mold of FIG. 7 from the radially inner side of the plug.

FIG. 9 provides a perspective view of the recessed mold cavity into which the counter molding plug fits from the radially outer side of the cavity.

FIG. 10 provides a perspective view of a mold segment and a counter molding plug assembled into the mold cavity of the mold.

The use of identical or similar reference numerals in different figures denotes identical or similar features.

### DETAILED DESCRIPTION OF THE INVENTION

The present invention provides an integrally molded container for attaching a tire monitoring sensor to the interior of a tire in the crown region of the tire. For purposes of describing the invention, reference now will be made in detail to embodiments and/or methods of the invention, one or more examples of which are illustrated in or with the drawings. Each example is provided by way of explanation of the invention, not limitation of the invention. In fact, it will be apparent to those skilled in the art that various modifications and variations can be made in the present invention without departing from the scope or spirit of the invention. For instance, features or steps illustrated or described as part of one embodiment, can be used with another embodiment or steps to yield a still further embodiments or methods. Thus, it is intended that the present invention covers such modifications and variations as come within the scope of the appended claims and their equivalents.

The following terms are defined as follows for this disclosure:

“Axial direction” or the letter “A” in the figures refers to a direction parallel to the axis of rotation of for example, tire or wheel as it travels along a road surface or the corresponding mold part.

“Radial direction” or the letter “R” in the figures refers to a direction that is orthogonal to the axial direction and extends in the same direction as any radius that extends orthogonally from the axial direction.

“Equatorial plane” means a plane that passes perpendicular to the axis of rotation and bisects the outer tread band and/or wheel structure or corresponding mold part.

“Circumferential direction” or the letter “C” in the figures refers to a direction is orthogonal to the axial direction and orthogonal to a radial direction.

“Radial plane” means a plane that passes perpendicular to the equatorial plane and through the axis of rotation of the wheel or corresponding mold part.

“Lateral direction” or the letter “L” means a direction that is orthogonal to an equatorial plane.

“Crown” means, as used herein, the area of the tire containing reinforcement plies of the tire, extending from one shoulder of the tire to the adjacent shoulder.

“Shoulder” means the region of the tire adjacent to the reinforcement plie edges.

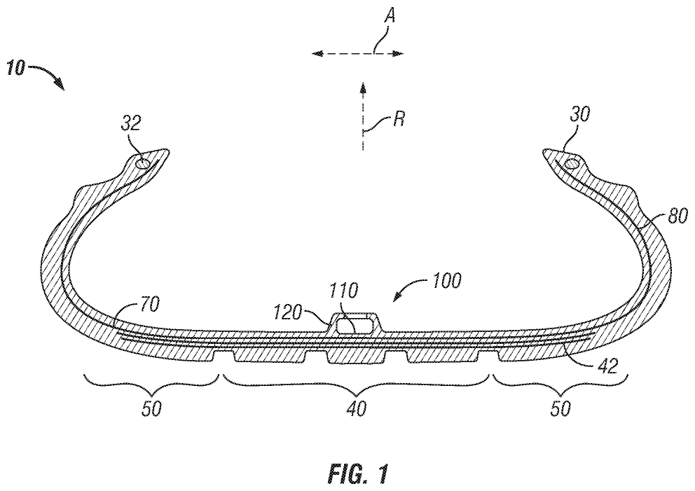

FIG. 1 provides a cross section of an exemplary embodiment of the invention depicting a cured pneumatic tire 10 containing an integrally formed container 100 for positioning and holding a sensor (not depicted). The cross section is taken along the radial plane of the tire and depicts the bead wire 32, tire body plies 80, crown reinforcement plies 42 and tread grooves. The container 100 of the embodiment shown is formed integrally with the tire 10 on interior portion of the tire carcass in the crown region 40 of the tire. In this particular embodiment, the container 100 is positioned along the tire's equatorial plane. In alternative embodiments, the container 100 may be positioned closer to one of the sidewalls of the tire and not centered on the tire's equatorial plane.

In the exemplary embodiment shown, the container 100 is formed from the same elastomer as is used in the molding of the tire's inner liner 70. In other embodiments the container 100 may be formed by a combination of elastomer used to form the inner liner and another elastomer used to construct the tire. In yet other embodiments, the type of elastomer used to form the container 100 is a unique formulation developed for molding the container itself but is not used in any significant amount for forming the remaining tire 10.

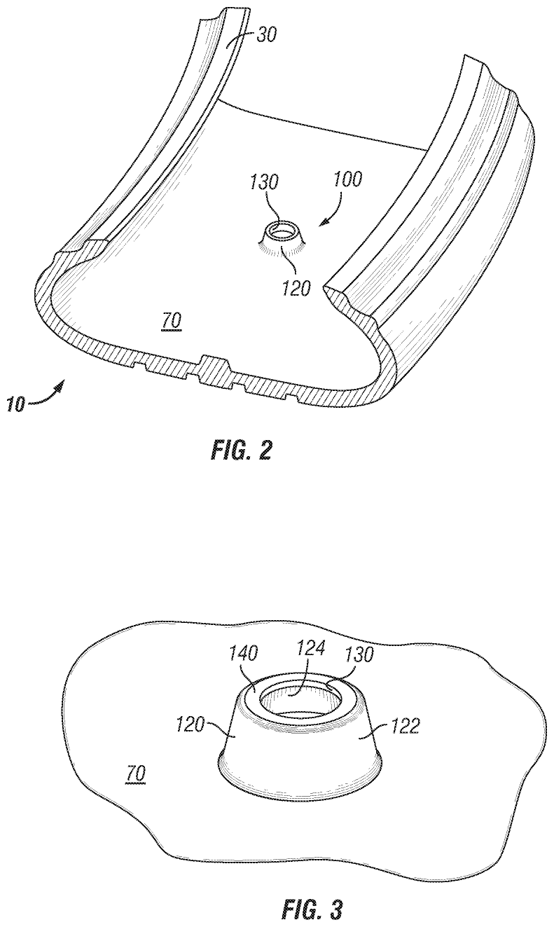

FIG. 2 provides a perspective partial view a tire 10 with an integrally formed container 100 positioned on the interior surface of the tire 10. The container of this embodiment is shown having a circular profile with a circular aperture 130 on the radially inner side of the container 100. The peripheral wall 120 of the container 100 extends radially inward from the inner liner 70 of the tire 10. It should be understood that other container shapes and geometries may be used within the scope of the invention, including containers having profiles of other shapes, such as having a rectangular profile.

FIG. 3 shows a close-up perspective partial view of the tire 10 shown in FIG. 2. The peripheral wall 120 tapers inward as it extends from the inner liner 70 of the tire. The peripheral wall 120 forms a flange 140 at the radially inward edge of the peripheral wall. The flange 140 extends radially inward from the wall 120 and possesses an aperture 130 through which a sensor may be inserted into the tire.

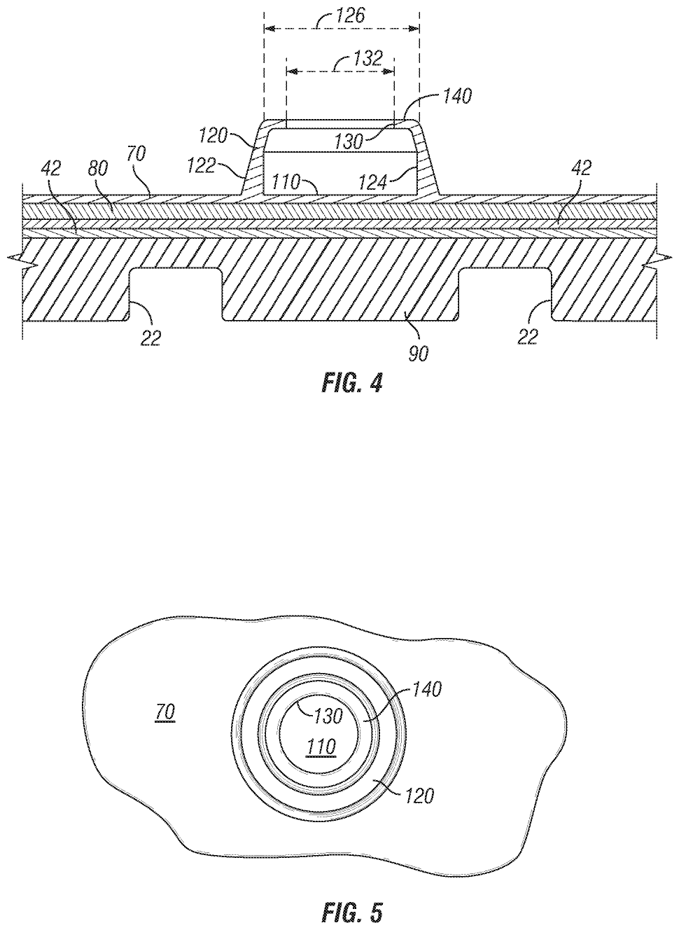

FIG. 4 shows a section view of the container 100 and depicts the inner liner layer 70, the tire body ply layer 80, the crown reinforcement plies 42 and tread rubber 90. Due to the molding process of the tire, the container may be formed from different elastomers, as a quantity of elastomer from the body ply layer may flow into the mold cavity creating the container. Alternatively, a quantity of elastomer may be located in the mold adjacent to the cavity forming the container and that elastomer may be different than the inner liner 70.

As shown here, the outer surface 122 of the peripheral walls 120 of the container taper inward as the walls 120 extend up from the inner liner 70 and base 110 of the container. The wall 120 thickness of the container 100 decreases as it extends upward. The aperture 130 possesses a maximum diameter 132 which is less than the maximum diameter 126 of the interior surface 124 of the peripheral wall 120 of the container. This provides resistance to the egress of an appropriately sized sensor placed within the cavity of the container 100. The flange 140 provides additional physical constraint to the removal of sensor from the container cavity. In other embodiments, the flange may be omitted.

FIG. 5 depicts an elevation view of the container showing the peripheral wall tapering inward toward the center of the container 100. The peripheral walls 120 surround the base 110, visible here through the aperture 130 of the container.

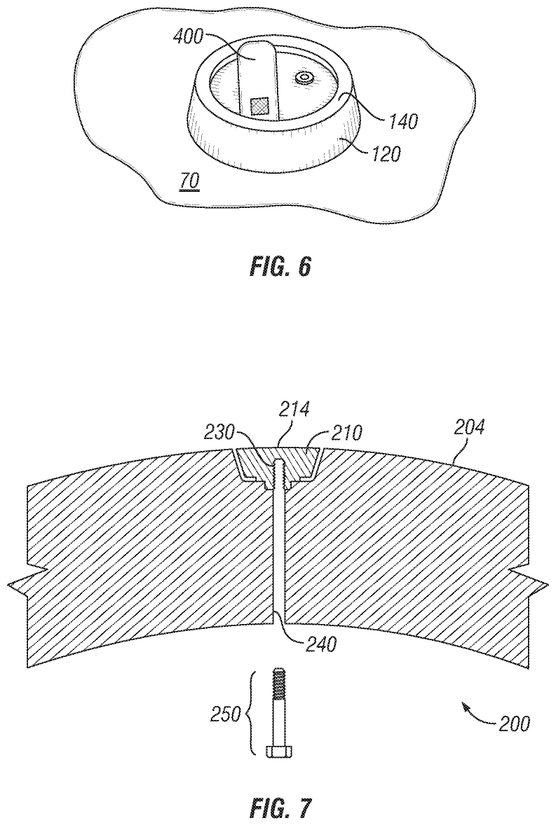

FIG. 6 depicts a typical sensor 400 placed within the container 100. The peripheral walls and flange 140 restrain the sensor 400 from moving within the pneumatic tire's internal cavity. Positioning the sensor at a particular location within the tire prevents damage to the sensor, the tire and allows for accurate balancing of the tire once mounted on a rim. The sensor 400 may be placed inside the container 100 and secured only by the physical fit of the sensor within the container. The sensor may alternatively be secured within the container using an adhesive to further restrain movement of the sensor.

In order to mold a container 100 as depicted herein, a rigid core tire mold is used, such as described in U.S. Pat. No. 4,895,692, upon which the layers of rubber and reinforcements are laid and the green, uncured, tire is constructed prior to the mold being closed and heated to allow for curing of the rubber components. FIG. 7 depicts a section view of a mold used to create a container 100. A typical rigid core tire mold is comprised of several mold segments which allow for the rigid core to collapse and allow removal of the finished cured tire once the molding stage has completed. A cavity is formed in the mold segment 200 and a counter molding plug 210 is secured within. Here the counter molding plug 210 is secured with a fastener 250 that extends from the radially inner side of the mold segment through an aperture 240 and into a threaded aperture 230 formed within the counter molding plug 210. Venting is provided by either the aperture 240 or additional vent tubes formed within the mold segment 200 allowing the rubber to flow within the cavity between the counter molding plug 210 and the mold segment 200. The radially outer surface 204 of the mold segment and the counter molding plug radially outer surface 214 may be curved along circumferential direction of the mold. Alternatively the counter molding plug radially outer surface 214 may be flat.

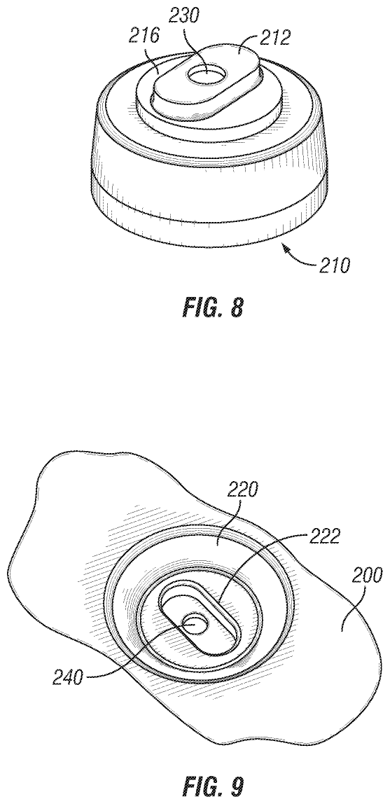

FIG. 8 depicts the radially outer portion of the counter molding plug 210. An alignment feature 212 is formed in this portion of the plug along the cut off surface 216 of the counter molding plug. In this embodiment, the alignment feature 212 if in the form of an alignment key 212 that prevents rotation of the counter molding plug when being secured and allows for orientation where the counter molding plug 210 possesses a curved surface. Alternatively the counter molding plug 210 may possess a flat surface 214 and still possess an alignment feature 212. Alternatively the alignment feature 212 may be absent from the counter molding plug 210 with the radially outer surface 214 being flat or, alternatively, curved.

FIG. 9 shows the counter molding plug cavity 220 into which the counter molding plug 210 is placed. The counter molding plug cavity possesses an alignment feature 222 in the base portion of the cavity. Here the alignment feature 222 is depicted as a counter molding plug cavity alignment keyslot 222 corresponding to the counter molding plug key 212 depicted in FIG. 8. As with the counter molding plug alignment feature, in alternative embodiments the counter molding plug cavity alignment feature may be absent from the cavity.

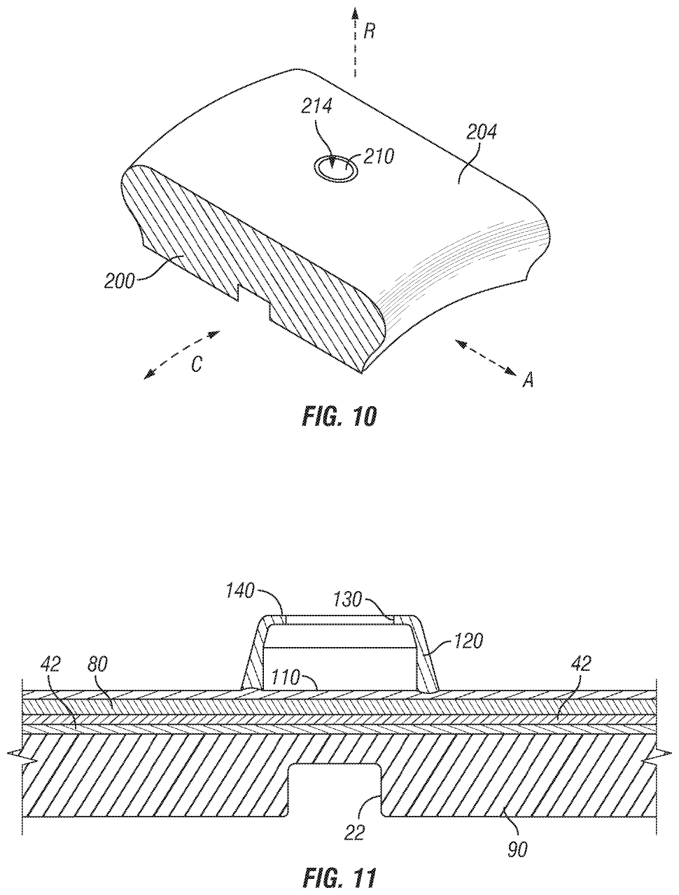

FIG. 10 depicts a perspective view of the mold segment 200 containing the counter molding plug 210. In this embodiment, the radially outer surface 214 of the counter molding plug 210 and the radially outer surface 204 of the mold segment 200 are aligned and curved along the circumferential direction.

Conventional construction methods of building and curing the tires using rigid core molds may be employed when constructing the embodiments of the invention depicted herein. An additional amount of material may be needed to compensate for the additional volume of mold space forming the container 100. In the embodiments shown, the tire is cured at approximately 170 degrees centigrade at a pressure in excess of 20 bar.

FIG. 11 depicts an alternative embodiment where the container is formed under a groove of the tire. When the tire is attached to a vehicle and the vehicle is operated, the tire rubber increases in temperature. Positioning the container 100 at a location above a tread groove 22 may reduce the temperature of the container 100 and sensor 400 contained therein. The location of the container above a tread groove is thought to improve the robustness of the sensor and tire by avoiding heat concentration above a rib of the tire. In this alternative embodiment the container is positioned closer to one lateral side of the tire than the other. Alternatively, where the longitudinal tread groove 22 is positioned equidistant from the right and left lateral sides, the container 100 may be positioned equidistant from the right and left lateral sides and still be formed under a tire rain groove 22. In this alternative embodiment the peripheral walls 120 of the container are formed with an elastomer composition different than the inner liner of the tire, but are otherwise formed integrally with the inner liner of the tire.

Selected combinations of aspects of the disclosed technology correspond to a plurality of different embodiments of the present invention. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.” Also, the dimensions and values disclosed herein are not limited to a specified unit of measurement. For example, dimensions expressed in English units are understood to include equivalent dimensions in metric and other units (e.g., a dimension disclosed as “1 inch” is intended to mean an equivalent dimension of “2.5 cm”).

As used herein, the term “method” or “process” refers to one or more steps that may be performed in other ordering than shown without departing from the scope of the presently disclosed invention. As used herein, the term “method” or “process” may include one or more steps performed at least by one electronic or computer-based apparatus. Any sequence of steps is exemplary and is not intended to limit methods described herein to any particular sequence, nor is it intended to preclude adding steps, omitting steps, repeating steps, or performing steps simultaneously. As used herein, the term “method” or “process” may include one or more steps performed at least by one electronic or computer-based apparatus having a processor for executing instructions that carry out the steps.

The terms “a,” “an,” and the singular forms of words shall be taken to include the plural form of the same words, such that the terms mean that one or more of something is provided. The terms “at least one” and “one or more” are used interchangeably. Ranges that are described as being “between a and b” are inclusive of the values for “a” and “b.”

Every document cited herein, including any cross-referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

What is claimed is:

1. A cured pneumatic tire comprising:
an inner liner forming an internal cavity of said tire;
a plurality of crown ply reinforcements; and
a container integrally formed with said inner liner adjacent to said crown ply reinforcements, said container comprising:
a base surface;
a peripheral wall surrounding said base surface, said peripheral wall extending away from said base, said peripheral wall having an outer surface and an inner surface, and said peripheral wall having a maximum wall diameter measured between said inner surface of opposing portions of said peripheral wall;
an aperture formed by said peripheral walls, said aperture having a maximum aperture diameter smaller than said maximum wall diameter.

2. The tire of claim 1 wherein said container possesses a circular shape.

3. The tire of claim 2 wherein said radial tire has an axis of rotation and said aperture is oriented toward the axis of rotation of the tire.

4. The tire of claim 1 further comprising a sensor, said sensor positioned within said container.

5. The tire of claim 4 wherein said sensor is part of a tire monitoring system.

6. The tire of claim 5 wherein said sensor monitors pressure.

7. The tire of claim 5 wherein said sensor monitors temperature.

8. The tire of claim 5 wherein said sensor monitors acceleration.

9. The tire of claim 1 wherein said inner liner and said container walls are comprised of the same elastomer.

10. The tire of claim 9 wherein said elastomer is comprised of a butyl rubber.

11. The tire of any one of claims 1 through 8 wherein said container walls are formed from an elastomer of a composition that is different than the elastomer of said inner liner.

12. The tire of claim 1 wherein said peripheral has a thickens measured from said inner surface to said outer surface, said thickness decreasing as said peripheral wall extends from said base.

13. The tire of claim 1 wherein said peripheral walls form a flange, said flange oriented in a plane parallel to said base surface, said aperture forming an edge of said flange.

14. The tire of claim 1 wherein said container is formed under a rain groove of the tire.

15. A method for securing a sensor to a cured pneumatic tire, the method comprising the steps of:
providing a tire mold having an outer mold portion and a core portion, said core possessing a cavity into which is positioned a counter-molding plug;
laying a quantity of uncured elastomer upon said core portion, the quantity of uncured rubber calculated to create sufficient pressure to force the rubber to flow into the space created between said cavity and said counter-molding plug during molding;
closing said tire mold;
heating said tire mold at a specified temperature profile for a specified period of time calculated to cure said uncured elastomer at the same time as the tire is cured;
opening said tire mold;
removing said tire from said mold.

16. The tire of claim 1 wherein a layer of rubber is adjacent to the inner liner and wherein the container walls are comprised of rubber from said layer adjacent to the inner liner.

17. The tire of claim 1 wherein said aperture is elongated.

18. The tire of claim 17 wherein the elongation of said aperture is oriented in the lateral direction of the tire.

19. A cured pneumatic tire comprising:
an inner liner forming an internal cavity of said tire;
a plurality of crown ply reinforcements; and
a container integrally formed from the inner liner adjacent to said crown ply reinforcements, said container comprising:
a base surface;
a peripheral wall surrounding said base surface, said peripheral wall extending away from said base, said peripheral wall having an outer surface and an inner surface, and said peripheral wall having a maximum wall diameter measured between said inner surface of opposing portions of said peripheral wall;
an aperture formed by said peripheral walls, said aperture having a maximum aperture diameter smaller than said maximum wall diameter.

20. The tire of claim 19 wherein a layer of rubber is adjacent to the inner liner and wherein the container walls are comprised of rubber from said layer adjacent to the inner liner.
